(19) United States
(12) Patent Application Publication
(10) Pub. No.: US 2026/0245908 A1
(43) Pub. Date: Aug. 20, 2026

(54) Composite binder for electrode sheet, and preparation method for and use of composite binder

(71) Applicants: MICROVAST POWER SYSTEMS CO., LTD., Huzhou, Zhejiang (CN); MICROVAST, INC., Stafford, TX (US); MICROVAST ADVANCED MEMBRANE INC., Stafford, TX (US)

(72) Inventors: Jiangping YI, Huzhou, Zhejiang (CN); Xuebing FENG, Huzhou, Zhejiang (CN); Feixiang HAO, Huzhou, Zhejiang (CN); Li GUAN, Huzhou, Zhejiang (CN); Nan FENG, Huzhou, Zhejiang (CN); Mattis WENJUAN-LIU, Stafford, TX (US); Yang WU, Bigfork, MT (US)

(73) Assignees: MICROVAST POWER SYSTEMS CO., LTD., Huzhou, Zhejiang (CN); MICROVAST, INC., Stafford, TX (US); MICROVAST ADVANCED MEMBRANE INC., Stafford, TX (US)

(21) Appl. No.: 19/162,013

(22) PCT Filed: Mar. 1, 2024
(86) PCT No.: PCT/CN2024/079715

§ 371 Date: Sep. 3, 2025

Related U.S. Application Data
(60) Provisional application No. 63/449,627, filed on Mar. 3, 2023.

(51) Int. Cl. H01M 4/62; H01M 4/02; H01M 4/04; H01M 4/1391; H01M 4/525; H01M 10/0525

(52) U.S. Cl. CPC H01M 4/623; H01M 4/1391; H01M 4/525; H01M 4/625; H01M 2004/027; H01M 2004/028; H01M 4/0435; H01M 10/0525

(57) ABSTRACT

Provided is a composite binder for an electrode sheet, and a preparation method for and a use of the composite binder. The composite binder for an electrode sheet uses both a fluorine-containing polymer and an aromatic polyamide. Compared with using a fluorine-containing polymer alone, the strength of the composite binder of the present application is enhanced, the peeling strength of the battery electrode sheet is higher, and the electrolyte infiltration effect is better. Compared with using aromatic polyamide alone, the moisture content of the battery electrode sheet is lower, the hygroscopicity is reduced, and the internal resistance of a battery cell is also lower. That is, the composite binder for an electrode sheet of the present application can have both the advantages of good electrochemical performance of the fluorine-containing polymer and high bonding strength of the aromatic polyamide, and the use cost of the binder is also reduced.

### CROSS-REFERENCE TO RELATED APPLICATIONS

The present application is a National Stage of International Patent Application No: PCT/CN2024/079715 filed on Mar. 1, 2024, which claims priority to U.S. Provisional Patent Application No. 63/449,627 filed on Mar. 3, 2023. The entire content of the aforesaid applications is hereby incorporated by reference.

### TECHNICAL FIELD

The present application relates to the technical field of lithium ion batteries, in particular to a composite binder for an electrode sheet, a preparation method therefor, and use thereof.

### BACKGROUND

A binder, as a part of an electrode material, accounts for a relatively small amount, but plays a vital role. Firstly, the binder can tightly attach an active material and a conductive agent to a current collector to form a complete electrode, so as to prevent the active material from falling off and peeling during charging and discharging. Secondly, the active material and the conductive agent can be uniformly dispersed, thereby forming a good electron and ion transport network and realizing the efficient transport of electrons and lithium ions. As PVDF has good thermodynamic and electrochemical stability, it has been widely used in the manufacture of lithium ion battery electrode sheets. However, PVDF also has the problems of a relatively low bonding strength, insufficient stability, and higher costs. The electrochemical stability of a PVDF binder under high-temperature condition is significantly reduced, and C-F in the structure is decomposed when the temperature is high, which will cause a side reaction to occur in the electrode.

Chinese patent CN 101432830 A disclosed a method for manufacturing an electrode sheet capable of handling charging and discharging under high-temperature, dry, and high voltage conditions by using m-aromatic polyamide as a binder. Chinese patent CN 112805855 A disclosed a non-aqueous secondary battery binder containing a fibrid of an aromatic polyamide. The binder powder was less likely to fall off and would not completely cover the surface of active material particles when used as a binder in the electrode layer. However, all of the inventions above use an aromatic polyamide alone as a binder, which may cause problems such as easy moisture absorption of electrode sheet and high internal resistance of a cell.

### SUMMARY

The main purpose of the present application is to provide a composite binder for an electrode sheet, a preparation method therefor, and use thereof, so as to solve the problems in the prior art that electrode sheets have a low bonding strength and are easy to absorb moisture, and cells have a high internal resistance.

In order to achieve the described object, according to one aspect of the present application, provided is a composite binder for an electrode sheet, including a fluorine-containing polymer and an aromatic polyamide.

Further, a mass ratio of the fluorine-containing polymer to the aromatic polyamide is (15:1)-(1:10).

Further, the composite binder for an electrode sheet further includes a non-aqueous solvent, and a total mass percentage content of the fluorine-containing polymer and the aromatic polyamide is 1-6.25%.

Further, the fluorine-containing polymer includes one or more of polyvinylidene fluoride, polytetrafluoroethylene, and polychlorotrifluoroethylene.

Further, a weight-average molecular weight of the aromatic polyamide is 10000-500000.

Further, the aromatic polyamide includes one or more of poly(p-benzamide), poly(m-phenylene isophthalamide), and poly(p-phenylene terephthalamide).

According to another aspect of the present application, provided is a preparation method for the described composite binder for an electrode sheet, including the following steps: step S1, adding the aromatic polyamide into a solvent to obtain a first solution; step S2, adding the fluorine-containing polymer into a solvent to obtain a second solution; and step S3, mixing the first solution and the second solution to obtain a composite binder for an electrode sheet.

Further, the solvent is a non-aqueous solvent.

Further, in the first solution, a mass percentage content of the aromatic polyamide is 1-6.25%.

Further, in the second solution, a mass percentage content of the fluorine-containing polymer is 1-6.25%. Further, a solid content of the composite binder for an electrode sheet is 1-6.25%.

According to another aspect of the present application, provided is a slurry including the composite binder for an electrode sheet of the present application.

Further, the slurry further includes a conductive agent and an active material.

Further, the conductive agent includes one or more of SP, VGCF, CNT, acetylene black, conductive graphite, and graphene, and the active material includes one or more of lithium iron phosphate, lithium manganese oxide, lithium nickel cobalt manganese oxide, lithium nickel cobalt aluminum oxide, lithium manganese iron phosphate, and lithium titanate.

According to another aspect of the present application, provided is an electrochemical device, including an electrode sheet, wherein the electrode sheet includes a current collector and a material coating, and the material coating includes the composite binder for an electrode sheet of the present application.

Further, the total mass percentage content of the fluorine-containing polymer and the aromatic polyamide in the material coating is 0.5-5%.

Further, the electrochemical device includes a secondary battery and/or a capacitor, wherein the secondary battery includes a lithium ion battery and/or a sodium ion battery.

The composite binder for an electrode sheet of the present application uses both a fluorine-containing polymer and an aromatic polyamide. Compared with using a fluorine-containing polymer alone, the strength of the composite binder of the present application is enhanced, the peeling strength of the battery electrode sheet is higher, and the electrolyte infiltration effect is better. Compared with using aromatic polyamide alone, the moisture content of the battery electrode sheet is lower, the hygroscopicity is reduced, and the internal resistance of a battery cell is also lower. That is, the composite binder for an electrode sheet of the present application can have the both advantages of good electrochemical performance of the fluorine-containing polymer and high bonding strength of the aromatic polyamide, and the use cost of the binder is also reduced.

### BRIEF DESCRIPTION OF THE DRAWINGS

The accompanying drawings, which form a part of the present application, are used for providing a further understanding of the present application. The schematic examples and illustrations of the present application are used for explaining the present application, and do not form improper limits to the present application. In the drawings:

FIG. 1 shows a photograph of electrolyte climbing test results according to Comparative example 1 and Example 5 of the present application; and

FIG. 2 shows cycle performance test results according to Example 1 and Example 2 of the present application.

### DETAILED DESCRIPTION OF THE EMBODIMENTS

It should be noted that examples in the present application and features in the examples may be combined with each other without conflicting. The present application is described in detail below with reference to the drawings and in combination with the examples.

As stated in the background section of the present application, the problems that electrode sheets have a low bonding strength and are easy to absorb moisture, and cells have a high internal resistance exist in the prior art. In order to solve the described problems, in an exemplary embodiment of the present application, provided is a composite binder for an electrode sheet, including a fluorine-containing polymer and an aromatic polyamide.

The fluorine-containing polymer has good electrochemical properties and good humidity stability, but has high use costs, and has an insufficient bonding strength when used alone as a binder. The aromatic polyamide has a high bonding strength, but its use alone as a binder causes the electrode sheet easy to absorb moisture and increases the cell internal resistance. The composite binder for an electrode sheet of the present application uses both a fluorine-containing polymer and an aromatic polyamide. Compared with using a fluorine-containing polymer alone, the strength of the composite binder of the present application is enhanced, the peeling strength of the battery electrode sheet is higher, and the electrolyte infiltration effect is better. Compared with using aromatic polyamide alone, the moisture content of the battery electrode sheet is lower, the hygroscopicity is reduced, and the internal resistance of a battery cell is also lower. That is, the composite binder for an electrode sheet of the present application can have the both advantages of good electrochemical performance of the fluorine-containing polymer and high bonding strength of the aromatic polyamide, and the use cost of the binder is also reduced.

In the composite binder for an electrode sheet of the present application, when the use proportion of the fluorine-containing polymer is too small and the use proportion of the aromatic polyamide is too large, the humidity stability of the composite binder for an electrode sheet is poor, the internal resistance of the cell is increased. When the use proportion of the fluorine-containing polymer is too large and the use proportion of the aromatic polyamide is too small, the strength of the composite binder will be insufficient, and meanwhile the costs will be further increased. Therefore, in an alternative embodiment, the mass ratio of the fluorine-containing polymer to the aromatic polyamide is (15:1)-(1:10), preferably (10:1)-(1:5), and more preferably (8:1)-(1:2). The mass ratio of the fluorine-containing polymer to the aromatic polyamide is not limited to the described range, and when in the described range, a high strength of the composite binder for an electrode sheet, good humidity stability for the electrode sheet, and a low internal resistance of the cell can be better taken into account.

Typically, but non-limiting, the mass ratio of the fluorine-containing polymer to the aromatic polyamide is 15:1, 14:1, 13:1, 12:1, 11:1, 10:1, 9:1, 8:1, 7:1, 6:1, 5:1, 4:1, 3:1, 2:1, 1.3:1, 1:1, 1:2, 1:3, 1:4, 1:5, 1:6, 1:7, 1:8, 1:9, 1:10 or a value range between any two of the ratios.

In an alternative embodiment, the composite binder for an electrode sheet further includes a non-aqueous solvent, and the total mass percentage content of the fluorine-containing polymer and the aromatic polyamide is 1-6.25%, including, but not limited to, 1%, 1.4%, 1.5%, 2%, 2.5%, 2.9%, 3%, 3.1%, 3.5%, 4%, 4.5%, 5%, 5.5%, 6%, 6.25%, or a value range formed by any two of these numerical values. The proportion of the fluorine-containing polymer and the aromatic polyamide in the composite binder for an electrode sheet defined in the present application falls within the described range, which can better enable the non-aqueous solvent to be homogeneously mixed and dispersed with functional materials in the electrode sheet slurry, and a person skilled in the art would be able to adjust the range according to preparation requirements.

In an alternative embodiment, the fluorine-containing polymer includes one or more of polyvinylidene fluoride, polytetrafluoroethylene, and polychlorotrifluoroethylene. The described fluorine-containing polymer has better electrochemical properties and humidity stability, and can further improve the comprehensive performance of the composite binder for an electrode sheet.

In an alternative embodiment, the weight-average molecular weight of the aromatic polyamide is 10000-500000; preferably, the aromatic polyamide includes one or more of poly(p-benzamide), poly(m-phenylene isophthalamide), and poly(p-phenylene terephthalamide). The described aromatic polyamide can further improve the bonding strength of the composite binder for an electrode sheet.

The present application has no special requirements for the type of the non-aqueous solvent, as long as the non-aqueous solvent can dissolve the fluorine-containing polymer and the aromatic polyamide well, for example, the non-aqueous solvent is NMP.

Typically, but not limiting, the weight-average molecular weight of the aromatic polyamide is 10000, 20000, 30000, 40000, 50000, 100000, 150000, 200000, 250000, 300000, 350000, 400000, 450000, 500000, or a value range between any two of the numerical values.

In another typical embodiment of the present application, also provided is a preparation method for the composite binder for an electrode sheet of the present application, including the following steps: step S1, adding an aromatic polyamide into a solvent to obtain a first solution; step S2, adding a fluorine-containing polymer into a solvent to obtain a second solution; and step S3, mixing the first solution and the second solution to obtain a composite binder for an electrode sheet.

In the present application, firstly, a fluorine-containing polymer and an aromatic polyamide are respectively dissolved, and then the dissolved solutions are mixed to obtain the composite binder for an electrode sheet of the present application. The preparation method is simple and easy to implement, and the obtained composite binder can have a good bonding strength, humidity stability, and electrochemical properties. Alternatively, the fluorine-containing polymer and the aromatic polyamide can be added into the solvent sequentially to obtain the composite binder for an electrode sheet, and the order of addition is not limited, and a person skilled in the art would be able to make a selection as needed.

In an alternative embodiment, the solvent is a non-aqueous solvent and can further improve dissolution of the fluorine-containing polymer and the aromatic polyamide.

In order to ensure that the composite binder for an electrode sheet has good bonding strength, humidity stability, and electrochemical properties, while further increasing the ductility of the composite binder and making it better mixed and dispersed with other functional materials in the electrode sheet slurry, in an alternative embodiment, the mass percentage content of the aromatic polyamide in the first solution is 1-6.25%; preferably, in the second solution, the mass percentage content of the fluorine-containing polymer is 1-6.25%; and preferably, the solid content of the composite binder for an electrode sheet is 1-6.25%, which is more convenient for practical application of the composite binder for an electrode sheet of the present application. The solid content refers to the total content of the fluorine-containing polymer and the aromatic polyamide in the solution of the composite binder for an electrode sheet.

Typically, but not limiting, the mass percentage content of the aromatic polyamide in the first solution is 1%, 1.4%, 1.5%, 2%, 2.5%, 2.9%, 3%, 3.1%, 3.5%, 4%, 4.5%, 5%, 5.5%, 6%, 6.25%, or a value range between any two of the numerical values; the mass percentage content of the fluorine-containing polymer in the second solution is 1%, 1.4%, 1.5%, 2%, 2.5%, 2.9%, 3%, 3.1%, 3.5%, 4%, 4.5%, 5%, 5.5%, 6%, 6.25%, or a value range between any two of the numerical values; and the solid content of the composite binder for an electrode sheet is 1%, 1.4%, 1.5%, 2%, 2.5%, 2.9%, 3%, 3.1%, 3.5%, 4%, 4.5%, 5%, 5.5%, 6%, 6.25%, or a value range between any two of the numerical values.

In another typical embodiment of the present application, also provided is a slurry, including the composite binder for an electrode sheet of the present application, and the slurry has good bonding strength, humidity stability, and electrochemical properties, and is suitable for use in the electrode sheet.

In an alternative embodiment, the slurry further includes a conductive agent and an active material; as long as the conductive agent has the function of improving the conductivity of the electrode sheet, the material thereof is not particularly limited; and as long as the active material can function as an electrode, the material thereof is not particularly limited. Preferably, the conductive agent includes one or more of SP, VGCF, CNT, acetylene black, conductive graphite, and graphene; and/or the active material includes one or more of lithium iron phosphate, lithium manganese oxide, lithium nickel cobalt manganese oxide, lithium nickel cobalt aluminum oxide, lithium manganese iron phosphate, and lithium titanate. The described conductive agent and active material are more suitable for being used in combination with the composite binder for an electrode sheet of the present application, and are further uniformly dispersed therein, thereby forming a better electron and ion transmission network and realizing more efficient transmission of electrons and lithium ions.

In another typical embodiment of the present application, also provided is an electrochemical device, including the electrode sheet, wherein the electrode sheet includes a current collector and a material coating, and the material coating includes the composite binder for an electrode sheet of the present application. The active material and the conductive agent can be both uniformly dispersed and closely attached to the current collector, so that the electrochemical device has a higher electrode sheet peeling strength, a lower electrode sheet moisture, and a lower cell internal resistance at the same time.

In order to further increase the peeling strength of the electrode sheet of the electrochemical device while reducing the electrode sheet moisture and cell internal resistance, in an alternative embodiment, the total mass percentage content of the fluorine-containing polymer and the aromatic polyamide in the material coating is 0.5-5%; preferably 0.5-3%; and more preferably 1-2%; and in the case where the content of the binder is lower than that of a conventional binder and the costs of the binder are further reduced, the peeling strength of the electrode sheet is greater after using the composite binder for an electrode sheet of the present application.

Typically, but not limiting, the total mass percentage content of the fluorine-containing polymer and the aromatic polyamide is 0.5%, 0.8%, 1%, 1.2%, 1.4%, 1.6%, 1.8%, 2%, 2.2%, 2.4%, 2.6%, 2.8%, 3%, 3.2%, 3.4%, 3.6%, 3.8%, 4%, 4.2%, 4.4%, 4.6%, 4.8%, 5%, or a value range between any two of the numerical values.

Specifically, in an alternative embodiment, the electrochemical device includes a secondary battery and/or a capacitor, and the secondary battery includes a lithium ion battery and/or a sodium ion battery.

The present application will be further described in detail with reference to the following embodiments, which should not be construed as limiting the scope of protection of the present application.

Unless otherwise specified, the aromatic polyamide (aramid) used in the following examples and comparative examples in the present application is poly(m-phenylene isophthalamide) (m-aramid) having a molecular weight of 200000 to 300000.

Unless otherwise specified, the lithium nickel cobalt manganese oxide used in the following examples and comparative examples in the present application is NCM811, and the electrolyte solvent used in an electrolyte injection process is EC+DEC+EMC, and the lithium salt is LiPF₆.

### Example 1

(1) 0.021 Kg of aramid was added into 2.079 Kg of NMP, and stirred uniformly to obtain an aramid glue solution;
(2) 0.169 Kg of PVDF was added into 2.535 Kg of NMP, and stirred uniformly to obtain a PVDF glue solution;
(3) The described aramid glue solution and PVDF glue solution were mixed and stirred uniformly, and then 0.211 Kg of SP (superconducting carbon black) and 0.158 Kg of VGCF were added and stirred uniformly to obtain a conductive glue;
(4) 10 Kg of lithium nickel cobalt manganese oxide was added into the described conductive glue, and stirred uniformly to obtain slurry;
(5) The described slurry was coated on an aluminum foil, dried, and subjected to roll-pressing and die cutting to obtain a positive electrode sheet, and the peeling strength of the positive electrode sheet was tested;
(6) The described positive electrode sheet, a graphite negative electrode sheet, and a separator were stacked to obtain a bare cell;
(7) The described bare cell was assembled, baked, injected with an electrolyte, formed, and subjected to capacity grading to form a cell having a capacity of 52 Ah. The moisture of the positive electrode sheet was tested before injecting the electrolyte, and the alternating current internal resistance of the cell was tested after capacity grading.

### Example 2

(1) 0.042 Kg of aramid was added into 4.158 Kg of NMP, and stirred uniformly to obtain an aramid glue solution;
(2) 0.126 Kg of PVDF was added into 1.89 Kg of NMP, and stirred uniformly to obtain a PVDF glue solution;
(3) The described aramid glue solution and PVDF glue solution were mixed and stirred uniformly, and then 0.211 Kg of SP and 0.158 Kg of VGCF were added and stirred uniformly to obtain conductive glue;
(4) 10 Kg of lithium nickel cobalt manganese oxide was added into the described conductive glue, and stirred uniformly to obtain slurry;
(5) The described slurry was coated on an aluminum foil, dried, and subjected to roll-pressing and die cutting to obtain a positive electrode sheet, and the peeling strength of the positive electrode sheet was tested;
(6) The described positive electrode sheet, a graphite negative electrode sheet, and a separator were stacked to obtain a bare cell;
(7) The described bare cell was assembled, baked, injected with an electrolyte, formed, and subjected to capacity grading to form a cell having a capacity of 52 Ah. The moisture of the positive electrode sheet was tested before injecting the electrolyte, and the alternating current internal resistance of the cell was tested after capacity grading.

### Example 3

(1) 0.063 Kg of aramid was added into 5.0 Kg of NMP, and stirred uniformly to obtain an aramid glue solution;
(2) 0.084 Kg of PVDF was added into 1.26 Kg of NMP, and stirred uniformly to obtain a PVDF glue solution;
(3) The described aramid glue solution and PVDF glue solution were mixed and stirred uniformly, and then 0.211 Kg of SP and 0.158 Kg of VGCF were added and stirred uniformly to obtain conductive glue;
(4) 10 Kg of lithium nickel cobalt manganese oxide was added into the described conductive glue, and stirred uniformly to obtain slurry;
(5) The described slurry was coated on an aluminum foil, dried, and subjected to roll-pressing and die cutting to obtain a positive electrode sheet, and the peeling strength of the positive electrode sheet was tested;
(6) The described positive electrode sheet, a graphite negative electrode sheet, and a separator were stacked to obtain a bare cell;
(7) The described bare cell was assembled, baked, injected with an electrolyte, formed, and subjected to capacity grading to form a cell having a capacity of 52 Ah. The moisture of the positive electrode sheet was tested before injecting the electrolyte, and the alternating current internal resistance of the cell was tested after capacity grading.

### Example 4

(1) 0.084 Kg of aramid was added into 6.0 Kg of NMP, and stirred uniformly to obtain an aramid glue solution;
(2) 0.042 Kg of PVDF was added into 0.63 Kg of NMP, and stirred uniformly to obtain a PVDF glue solution;
(3) The described aramid glue solution and PVDF glue solution were mixed and stirred uniformly, and then 0.211 Kg of SP and 0.158 Kg of VGCF were added and stirred uniformly to obtain conductive glue;
(4) 10 Kg of lithium nickel cobalt manganese oxide was added into the described conductive glue, and stirred uniformly to obtain slurry;
(5) The described slurry was coated on an aluminum foil, dried, and subjected to roll-pressing and die cutting to obtain a positive electrode sheet, and the peeling strength of the positive electrode sheet was tested;
(6) The described positive electrode sheet, a graphite negative electrode sheet, and a separator were stacked to obtain a bare cell;
(7) The described bare cell was assembled, baked, injected with an electrolyte, formed, and subjected to capacity grading to form a cell having a capacity of 52 Ah. The moisture of the positive electrode sheet was tested before injecting the electrolyte, and the alternating current internal resistance of the cell was tested after capacity grading.

### Example 5

(1) 0.042 Kg of aramid was added into 4.158 Kg of NMP, and stirred uniformly to obtain an aramid glue solution;
(2) 0.169 Kg of PVDF was added into 2.535 Kg of NMP, and stirred uniformly to obtain a PVDF glue solution;
(3) The described aramid glue solution and PVDF glue solution were mixed and stirred uniformly, and then 0.211 Kg of SP and 0.158 Kg of VGCF were added and stirred uniformly to obtain conductive glue;
(4) 10 Kg of lithium nickel cobalt manganese oxide was added into the described conductive glue, and stirred uniformly to obtain slurry;
(5) The described slurry was coated on an aluminum foil, dried, and subjected to roll-pressing and die cutting to obtain a positive electrode sheet, and the electrolyte climbing performance of the positive electrode sheet was tested.

### Example 6

(1) 0.011 Kg of aramid was added into 1.089 Kg of NMP, and stirred uniformly to obtain an aramid glue solution;
(2) 0.158 Kg of PVDF was added into 2.37 Kg of NMP, and stirred uniformly to obtain a PVDF glue solution;
(3) The described aramid glue solution and PVDF glue solution were mixed and stirred uniformly, and then 0.211 Kg of SP (superconducting carbon black) and 0.158 Kg of VGCF were added and stirred uniformly to obtain conductive glue;
(4) 10 Kg of lithium nickel cobalt manganese oxide was added into the described conductive glue, and stirred uniformly to obtain slurry;
(5) The described slurry was coated on an aluminum foil, dried, and subjected to roll-pressing and die cutting to obtain a positive electrode sheet, and the peeling strength of the positive electrode sheet was tested;
(6) The described positive electrode sheet, a graphite negative electrode sheet, and a separator were stacked to obtain a bare cell;
(7) The described bare cell was assembled, baked, injected with an electrolyte, formed, and subjected to capacity grading to form a cell having a capacity of 52 Ah. The moisture of the positive electrode sheet was tested before injecting the electrolyte, and the alternating current internal resistance of the cell was tested after capacity grading.

### Example 7

(1) 0.105 Kg of aramid was added into 7 Kg of NMP, and stirred uniformly to obtain an aramid glue solution;
(2) 0.010 Kg of PVDF was added into 0.15 Kg of NMP, and stirred uniformly to obtain a PVDF glue solution;
(3) The described aramid glue solution and PVDF glue solution were mixed and stirred uniformly, and then 0.211 Kg of SP (superconducting carbon black) and 0.158 Kg of VGCF were added and stirred uniformly to obtain conductive glue;
(4) 10 Kg of lithium nickel cobalt manganese oxide was added into the described conductive glue, and stirred uniformly to obtain slurry;
(5) The described slurry was coated on an aluminum foil, dried, and subjected to roll-pressing and die cutting to obtain a positive electrode sheet, and the peeling strength of the positive electrode sheet was tested;
(6) The described positive electrode sheet, a graphite negative electrode sheet, and a separator were stacked to obtain a bare cell;
(7) The described bare cell was assembled, and baked. The moisture of the positive electrode sheet was tested.

### Example 8

(1) 0.21 Kg of aramid was added into 7 Kg of NMP, and stirred uniformly to obtain an aramid glue solution;
(2) 0.314 Kg of PVDF was added into 1.57 Kg of NMP, and stirred uniformly to obtain a PVDF glue solution;
(3) The described aramid glue solution and PVDF glue solution were mixed and stirred uniformly, and then 0.211 Kg of SP (superconducting carbon black) and 0.158 Kg of VGCF were added and stirred uniformly to obtain conductive glue;
(4) 10 Kg of lithium nickel cobalt manganese oxide was added into the described conductive glue, and stirred uniformly to obtain slurry;
(5) The described slurry was coated on an aluminum foil, dried, and subjected to roll-pressing and die cutting to obtain a positive electrode sheet, and the peeling strength of the positive electrode sheet was tested;
(6) The described positive electrode sheet, a graphite negative electrode sheet, and a separator were stacked to obtain a bare cell;
(7) The described bare cell was assembled, and baked. The moisture of the positive electrode sheet was tested.

### Example 9

(1) 0.052 Kg of aramid was added into 5.148 Kg of NMP, and stirred uniformly to obtain an aramid glue solution;
(2) 0.052 Kg of PVDF was added into 0.78 Kg of NMP, and stirred uniformly to obtain a PVDF glue solution;
(3) The described aramid glue solution and PVDF glue solution were mixed and stirred uniformly, and then 0.211 Kg of SP (superconducting carbon black) and 0.158 Kg of VGCF were added and stirred uniformly to obtain conductive glue;
(4) 10 Kg of lithium nickel cobalt manganese oxide was added into the described conductive glue, and stirred uniformly to obtain slurry;
(5) The described slurry was coated on an aluminum foil, dried, and subjected to roll-pressing and die cutting to obtain a positive electrode sheet, and the peeling strength of the positive electrode sheet was tested;
(6) The described positive electrode sheet, a graphite negative electrode sheet, and a separator were stacked to obtain a bare cell;
(7) The described bare cell was assembled, and baked. The moisture of the positive electrode sheet was tested.

### Comparative Example 1

(1) 0.212 Kg of PVDF was added into 3.18 Kg of NMP, and stirred uniformly to obtain a PVDF glue solution;
(2) 0.211 Kg of SP and 0.158 Kg of VGCF were added into the described PVDF glue solution, and then 2.5 Kg of NMP was added and stirring uniformly to obtain conductive glue; (3) 10 Kg of lithium nickel cobalt manganese oxide was added into the described conductive glue, and stirred uniformly to obtain slurry;
(4) The described slurry was coated on an aluminum foil, dried, and subjected to roll-pressing and die cutting to obtain a positive electrode sheet, and the peeling strength and the electrolyte climbing performance of the positive electrode sheet was tested;
(5) The described positive electrode sheet, a graphite negative electrode sheet, and a separator were stacked to obtain a bare cell;
(6) The described bare cell was assembled, baked, injected with an electrolyte, formed, and subjected to capacity grading to form a cell having a capacity of 52 Ah. The moisture of the positive electrode sheet was tested before injecting the electrolyte, and the alternating current internal resistance of the cell was tested after capacity grading.

### Comparative Example 2

(1) 0.105 Kg of aramid was added into 7.0 Kg of NMP, and stirred uniformly to obtain an aramid glue solution
(2) 0.211 Kg of SP and 0.158 Kg of VGCF were added into the described aramid glue solution, and stirred uniformly to obtain conductive glue;
(3) 10 Kg of lithium nickel cobalt manganese oxide was added into the described conductive glue, and stirred uniformly to obtain slurry;
(4) The described slurry was coated on an aluminum foil, dried, and subjected to roll-pressing and die cutting to obtain a positive electrode sheet, and the peeling strength of the positive electrode sheet was tested;
(5) The described positive electrode sheet, a graphite negative electrode sheet, and a separator were stacked to obtain a bare cell;
(6) The described bare cell was assembled, baked, injected with an electrolyte, formed, and subjected to capacity grading to form a cell having a capacity of 52 Ah. The moisture of the positive electrode sheet was tested before injecting the electrolyte, and the alternating current internal resistance of the cell was tested after capacity grading.

### Performance Test:

Peeling strength test of the electrode sheet: it was performed according to standard GB/T 8808-1988.

Moisture test of the electrode sheet: the moisture of the positive electrode sheet was tested using a Karl Fisher moisture tester, the instrument model was Mettler-Toledo C30S, and the heating temperature of a portable butane stove was 150° C.

Capacity grading test: (1) standing for 10 min; (2) constant-current constant-voltage charging at 17.16 A with a cutoff voltage of 4.2 V and a cutoff current of 2.6 A; (3) standing for 10 min; (4) constant-current discharging at 17.16 A with a cut-off voltage of 2.7 V; (5) standing for 10 min; (6) constant-current constant-voltage charging at 17.16 A with a cut-off voltage of 4.2 V and a cut-off current of 2.6 A. The test temperature was 25±3° C., and the instrument model was Xinwei 30A Test cabinet CT-4032-5V30A-NTFA.

Internal resistance test: the instrument model was Suzhou Rongfang BT3554, and the test frequency was 1000 Hz.

Electrolyte wetting effect test: for the electrolyte climbing test, a square container was taken, one end thereof was lifted to make it 30° with the horizontal, and an appropriate amount of an electrolyte (1M LiPF₆, EC/EMC=3/7) was added. The electrode sheet to be tested was cut into strips with a width of 10 mm, and the strips were put into a container at the same time. The initial electrolyte level of the electrode sheet must be kept consistent. After 10 minutes, the electrode sheet to be tested was taken out at the same time, and the electrolyte climbing height was observed.

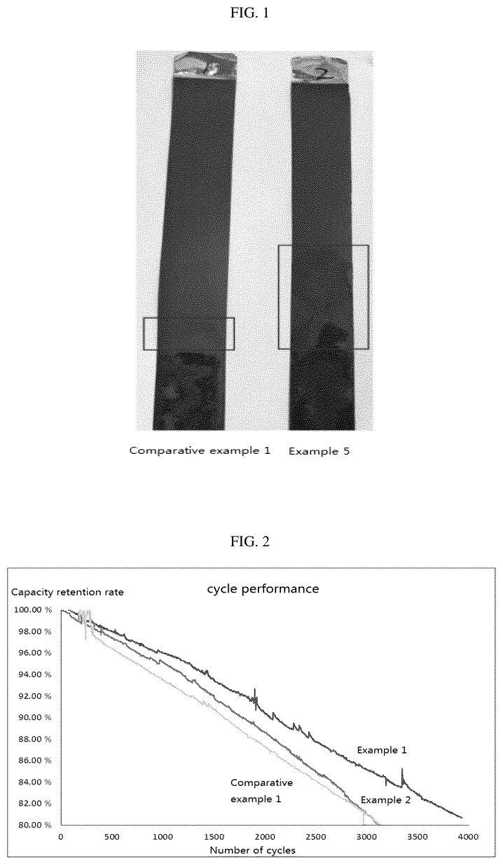

Test results of the electrode sheet peeling strength, the electrode sheet moisture, the cell graded capacity, and the cell alternating current internal resistance of each of the described Examples and Comparative examples were shown in Table 1. Photographs of the results of the electrolyte climbing test of Example 5 and Comparative example 1 were shown in FIG. 1, with the electrolyte climbing height shown in the box.

In addition, the batteries prepared in Example 1, Example 2, and Comparative Example 1 were tested for the electrolyte retention capacity and cycle life.

Electrolyte retention capacity test: When the cell was finally sealed, the weight of the cell before and after the cell was finally sealed was measured on a balance. The weight before final sealing minus the weight after final sealing was the electrolyte loss amount, and the injection amount minus the electrolyte loss amount was the electrolyte retention capacity. The electrolyte retention capacity of Example 1, Example 2, and Comparative Example 1 were 156.7 g, 158.6 g, and 144.9 g, respectively.

The cycle test procedure was as follows: (1) standing for 10 min; (2) discharging at a constant current of 52 A with a cut-off voltage of 2.7 V; (3) standing for 10 min; (4) charging at a constant current of 52 A and a constant voltage to 4.2 V with a cut-off current of 5.2 A; (5) standing for 10 min; (6) repeating the process steps (2)-(5) 4000 times; and (7) discharging at a constant current of 52 A with a cut-off voltage of 2.7 V. In the described cycle test, Xinwei 100A Test cabinet was used, and the model was CT-4016-5V100A-NTFA. The model of the specific test cabinet was not construed as a limitation to the present application, and test machines of other models can be used in the specific cycle test. The results of the cycle performance tests for Example 1, Example 2, and Comparative example 1 were shown in FIG. 2.

TABLE 1

| | | | | Moisture in | Cell | Cell |
|---|---|---|---|---|---|---|
| | Aramid | PVDF | Peeling | electrode | capacity | alternating |
| | content in | content in | strength of | sheet | after | current |
| | electrode | electrode | electrode | before | capacity | internal |
| | sheet | sheet | sheet | injection | grading | resistance |
| Test items | coating | coating | N/m | ppm | Ah | mΩ |
| Example 1 | 0.20% | 1.60% | 6.9 | 53 | 52.51 | 0.82 |
| Example 2 | 0.40% | 1.20% | 7.2 | 72 | 52.61 | 1.16 |
| Example 3 | 0.60% | 0.80% | 7.6 | 97 | 52.57 | 1.21 |
| Example 4 | 0.80% | 0.40% | 8.1 | 117 | 52.38 | 1.29 |
| Example 5 | 0.40% | 1.60% | — | — | — | — |
| Example 6 | 0.1% | 1.5% | 6.6 | 37 | 52.46 | 0.78 |
| Example 7 | 1.0% | 0.1% | 4.4 | 135 | — | — |
| Example 8 | 2.0% | 3.0% | 69.7 | 414 | — | — |
| Example 9 | 0.5% | 0.5% | 7.1 | 75 | — | — |
| Comparative | 0% | 2% | 6.3 | 37 | 52.85 | 0.70 |
| example 1 | | | | | | |
| Comparative | 1% | 0% | 4.0 | 130 | 52.16 | 1.38 |
| example 2 | | | | | | |

It can be determined from the described content that in each example of the present application, aramid mixed PVDF was used as a composite binder for an electrode sheet, and compared with the use of aramid alone as a binder in Comparative example 2, the electrode sheet had lower moisture content and a lower cell internal resistance. Compared with Comparative example 1, as the bonding performance of aramid was higher than that of PVDF, even if the binder content in each example was lower than that of Comparative example 1, the peeling strength of the electrode sheet was still higher than that of Comparative example 1. Compared with Comparative example 2, as the total amount of the binder in each example was higher than that of Comparative example 2, the peeling strength of the electrode sheet was also higher than that of Comparative example 2. In addition, by comparing the electrolyte climbing performance of Example 5 and Comparative example 1 in FIG. 1, it can be determined that the composite binder for the electrode sheet of the present application can significantly improve the electrolyte wetting performance of the electrode sheet.

By comparing the cycle performance of Example 1, Example 2, and Comparative example 1, the cycle performance of Example 1 was obviously superior to that of Comparative example 1, and the possible reason was that 0.2% of aramid was used to replace 0.4% of PVDF, and thus the electrolyte wetting performance of the electrode sheet was improved, thereby improving the electrolyte retention capacity and in turn improving the cycle performance. And for Example 2, although the electrolyte retention capacity was higher than that of Example 1, the alternating current internal resistance was increased, and the dynamic performance of the cell was reduced, and therefore the cycle performance was inferior to that of Example 1 and was close to that of Comparative example 1, however, the amount of the binder used was obviously lower than that of Comparative example 1.

Hence, the composite binder for an electrode sheet of the present application can simultaneously have the advantages of good electrochemical properties of a fluorine-containing polymer and a high bonding strength of an aromatic polyamide, and also reduce the use costs of the binder.

The above are only preferred examples of the present application and are not intended to limit the present application. For those skilled in the art, the present application may have various modifications and variations. Any modifications, equivalent replacements, improvements and the like made within the spirit and principles of the present application shall be contained within the scope of protection of the present application.

1. A composite binder for an electrode sheet, comprising a fluorine-containing polymer and an aromatic polyamide.

2. The composite binder for an electrode sheet according to claim 1, wherein a mass ratio of the fluorine-containing polymer to the aromatic polyamide is (15:1)-(1:10).

3. The composite binder for an electrode sheet according to claim 1, wherein the composite binder for an electrode sheet further comprises a non-aqueous solvent, and a total mass percentage content of the fluorine-containing polymer and the aromatic polyamide is 1-6.25%.

4. The composite binder for an electrode sheet according to claim 1, wherein the fluorine-containing polymer comprises one or more of polyvinylidene fluoride, polytetrafluoroethylene, and polychlorotrifluoroethylene.

5. The composite binder for an electrode sheet according to claim 1, wherein a weight-average molecular weight of the aromatic polyamide is 10000-500000.

6. The composite binder for an electrode sheet according to claim 5, wherein the aromatic polyamide comprises one or more of poly(p-benzamide), poly(m-phenylene isophthalamide), and poly(p-phenylene terephthalamide).

7. A preparation method for the composite binder for an electrode sheet according to claim 1, comprising the following steps:
step S1, adding the aromatic polyamide into a solvent to obtain a first solution;
step S2, adding the fluorine-containing polymer into the solvent to obtain a second solution; and
step S3, mixing the first solution and the second solution to obtain the composite binder for an electrode sheet.

8. The preparation method according to claim 7, wherein the solvent is a non-aqueous solvent.

9. The preparation method according to claim 7, wherein in the first solution, a mass percentage content of the aromatic polyamide is 1-6.25%; and/or in the second solution, a mass percentage content of the fluorine-containing polymer is 1-6.25%.

10. The preparation method according to claim 7, wherein a solid content of the composite binder for an electrode sheet is 1-6.25%.

11. A slurry, comprising the composite binder for an electrode sheet according to claim 1.

12. The slurry according to claim 11, wherein the slurry further comprises a conductive agent and an active material.

13. The slurry according to claim 12, wherein the conductive agent comprises one or more of SP, VGCF, CNT, acetylene black, conductive graphite, and graphene; and the active material comprises one or more of lithium iron phosphate, lithium manganese oxide, lithium nickel cobalt manganese oxide, lithium nickel cobalt aluminum oxide, lithium manganese iron phosphate, and lithium titanate.

14. An electrochemical device, comprising an electrode sheet, wherein the electrode sheet comprises a current collector and a material coating, and the material coating comprises the composite binder for an electrode sheet according to claim 1.

15. The electrochemical device according to claim 14, wherein the total mass percentage content of the fluorine-containing polymer and the aromatic polyamide in the material coating is 0.5-5%.

16. The electrochemical device according to claim 14, wherein the electrochemical device comprises a secondary battery and/or a capacitor, and the secondary battery comprises a lithium ion battery and/or a sodium ion battery.

17. The composite binder for an electrode sheet according to claim 2, wherein the mass ratio of the fluorine-containing polymer to the aromatic polyamide is (10:1)-(1:5).

18. The composite binder for an electrode sheet according to claim 2, wherein the mass ratio of the fluorine-containing polymer to the aromatic polyamide is (8:1)-(1:2).

19. The electrochemical device according to claim 15, wherein the total mass percentage content of the fluorine-containing polymer and the aromatic polyamide in the material coating is 0.5-3%.

20. The electrochemical device according to claim 15, wherein the total mass percentage content of the fluorine-containing polymer and the aromatic polyamide in the material coating is 1-2%.
